(19) United States
(12) Patent Application Publication
(10) Pub. No.: US 2023/0409482 A1
(43) Pub. Date: Dec. 21, 2023

(54) MULTI-DIE PACKAGE

(71) Applicant: Fujitsu Limited, Kawasaki-shi (JP)

(72) Inventor: Hitoshi Matsumori, Kawasaki (JP)

(73) Assignee: Fujitsu Limited, Kawasaki-shi (JP)

(21) Appl. No.: 18/121,233

(22) Filed: Mar. 14, 2023

(30) Foreign Application Priority Data
Jun. 20, 2022 (JP) 2022-098904

(51) Int. Cl. G06F 12/0875

(52) U.S. Cl. CPC G06F 12/0875; G06F 2212/452

(57) ABSTRACT

A multi-die package comprises a plurality of dies each including a processor core, a service processor, a cache memory that holds an instruction to be executed by the service processor, and an arbiter. The plurality of the arbiters are coupled in series. Each arbiter, except the arbiter in the first stage, arbitrates between a read request from the service processor of the concerned die and a read request selected through arbitration by the arbiter in the previous stage, and outputs the read request selected through the arbitration to the arbiter in the next stage. The arbiter in the last stage outputs the read request selected through the arbitration to a memory. Each cache memory holds an instruction output from the memory in response to each of read requests output from the service processors of the concerned die and any of the other dies in association with the read request.

### CROSS-REFERENCE TO RELATED APPLICATION

This application is based upon and claims the benefit of priority of the prior Japanese Patent Application No. 2022-98904, filed on Jun. 20, 2022, the entire contents of which are incorporated herein by reference.

### FIELD

Embodiments discussed herein are related to a multi-die package.

### BACKGROUND

A system is known which gives priority to any one of multiple processor units coupled to a shared memory via bus, by using an arbiter chain in which arbiters included in the multiple processor units are coupled in series. The processor unit that is given the right to use the bus accesses the shared memory or outputs a common interrupt signal and an identification number(s) of one or more processor units to be caused to execute interrupt processing.

Japanese Laid-open Patent. Publication No. 58-197568 is disclosed as related art.

### SUMMARY

According to an aspect of the embodiments, a multi-die package comprises a plurality of dies each including a processor core, a service processor, a cache memory that holds an instruction to be executed by the service processor, and an arbiter that arbitrates between read requests issued from the service processors, wherein the plurality of the arbiters respectively mounted on the plurality of dies are coupled in series, each of the arbiters excluding the arbiter in the first stage and the arbiter in the last stage arbitrates between a read request from the service processor of the concerned die and a read request selected through arbitration by the arbiter in the previous stage, and outputs the read request selected through the arbitration to the arbiter in the next stage, the arbiter in the last stage arbitrates between a read request from the service processor of the concerned die and a read request selected through arbitration by the arbiter in the previous stage, and outputs the read request selected through the arbitration to a memory, and the cache memory of each of the plurality of dies holds an instruction output from the memory in response to each of read requests output from the service processors of the concerned die and any of the other dies in association with the read request.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram illustrating an example of a multi-die

package in an embodiment;

FIG. 2 is a block diagram illustrating an example of a die D2 in FIG. 1,

FIG. 3 is a block diagram illustrating an example of a die Dn in FIG. 1; and

FIG. 4 is a timing chart presenting an example of operations of an SPI controller and an arbiter of the die Dn in FIG. 3.

### DESCRIPTION OF EMBODIMENTS

In the activation of the above system, central processing units (CPUs) of the multiple processor units issue read requests respectively, and a read request issued by the CPU selected through arbitration by the arbiters among the read requests is output to the shared memory. An instruction for the CPU output from the shared memory in response to the read request is stored in a local memory of the processor unit of the issuer of the read request.

The read requests issued by the CPUs of the other processor units sequentially selected by the arbiters are also sequentially issued to the shared memory, and instructions output from the shared memory are sequentially stored in the local memories of the processor units of the issuers of the read requests. However, in the case where instructions are sequentially stored in the local memories of the multiple processor units in the activation of the system, the transfer time for transferring the instructions to the local memories in the system increases as the number of processor units increases.

According to one aspect, an object of the present disclosure is to improve efficiency in transfer of an instruction output from a memory in response to a read request selected through arbitration to multiple dies in a case where arbiters each of which arbitrates between read requests from service processors mounted on the multiple dies are coupled in series.

Hereinafter, embodiments will be described with reference to the drawings.

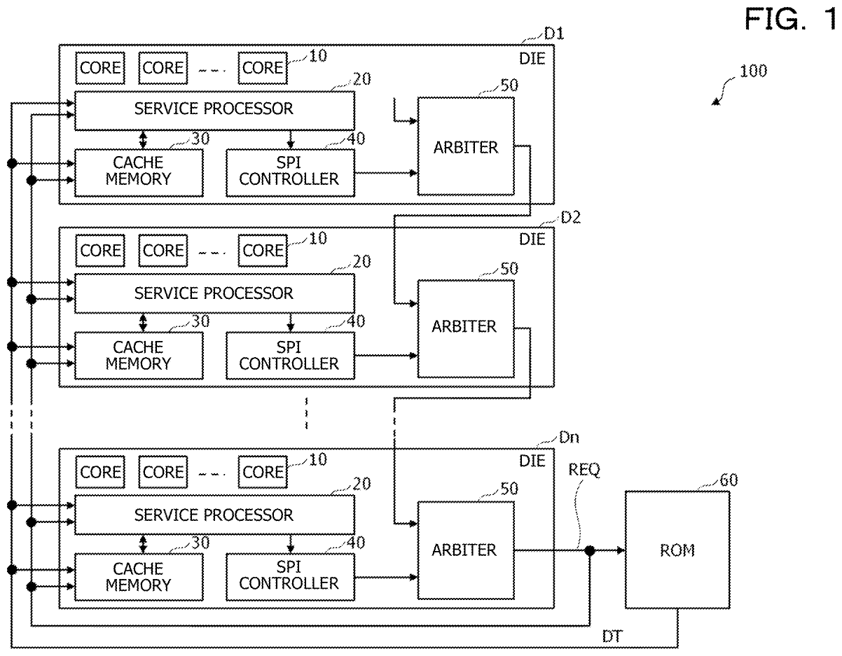

FIG. 1 illustrates an example of a multi-die package in an embodiment. A multi-die package 100 illustrated in FIG. 1 includes n dies D (D1, D2, . . . , Dn) and a read-only memory (ROM) 60. For example, the multi-die package 100 is mounted in an information processing apparatus such as a server or a supercomputer. Each die D includes multiple cores 10, a service processor a cache memory 30, a Serial Peripheral Interface (SPI: registered trademark) controller 40, and an arbiter 50.

Each of the multiple dies D implements any of multiple processing functions according to an information processing program executed by the cores 10. Examples of the multiple processing functions include an overall control function of the entire multi-die package 100, a calculation processing function, and an input/output (I/O) device processing function. The core 10 is an example of a processor core.

In the activation of the multi-die package 100, the service processor 20 executes an initialization program to initialize the concerned die D according to the processing function to be implemented by the concerned die D. The initialization of the concerned die D includes initialization of the cores 10 mounted on the concerned die D. After completion of the initialization of the concerned die D, the service processor 20 releases the reset of the cores 10 by supplying a clock to the cores 10. Thus, the cores 10 start operations and implement a predetermined processing function.

The cache memory 30 holds at least part of the initialization programs (instructions) to be executed by the service processor 20. For example, the cache memory 30 employs a set associative scheme, and includes at least one data area that holds data for each index address specified by a predetermined number of bits in an access address. When the data area specified by the index address in a cache-missed access address is fully occupied by data for another address, the cache memory 30 executes replacement processing of evicting the data held in the data area.

For example, one of the n dies D is an overall control processing die D in which the cores 10 execute overall control processing on operations of the entire multi-die package 100. For example, the service processor 20 of the overall control processing die D initializes the die D by executing an initialization program for setting the concerned die D for the overall control processing and an initialization program common to all the dies D.

For example, a predetermined number of dies D among the n dies D are calculation processing dies D in which the cores 10 execute calculation processing. For example, the service processor 20 of the calculation processing die D initializes the die D by executing an initialization program for setting the concerned die D for the calculation processing and the initialization program common to all the dies D.

For example, another predetermined number of dies D among the n dies D are input/output (I/O) processing dies D which are coupled to an input/output (I/O) device via an I/O interface of the multi-die package 100 and in each of which the cores 10 execute I/O processing. For example, the service processor 20 of the I/O processing die D initializes the die D by executing an initialization program for setting the concerned die D for the I/O processing and the initialization program common to all the dies D.

Based on activation (for example, power-on) of the multi-die package 100, the service processor 20 issues a read request (a read command and an address) for fetching an instruction of the initialization program. When data matching the read request is held in the cache memory 30 (cache hit), the service processor 20 fetches the data held in the cache memory 30 as the instruction. When data matching the read request is not held in the cache memory 30 (cache miss), the service processor 20 issues the read request to the SPI controller 40. Since the cache memory 30 is a volatile memory, the cache memory 30 does hold any data at the time of the activation of the multi-die package 100.

Instead of the service processor 20, the cache memory 30 may issue the read request to the SPI controller 40. In this case, the cache memory issues the read request to the SPI controller 40 when determining a cache miss.

The SPI controller 40 transfers the read request received from the service processor 20 to the arbiter 50. The die D may include a controller for another serial interface instead of the SPI controller 40, and may include a controller for a parallel interface such as a memory access controller. The die D does not have to include the SPI controller 40. In this case, the service processor directly outputs the read request to the arbiter 50.

The arbiter 50 arbitrates between a read request from the die D in the previous stage and a read request from the concerned SPI controller 40, and outputs the read request selected through the arbitration to the arbiter 50 or the ROM 60 of the die D in the next stage. For example, the arbiters 50 of the multiple dies D are coupled in series.

Since the arbiter 50 of the die D1 in the first stage receives only the read request from the concerned SPI controller 40, the arbiter 50 selects and outputs the received read request at all times. Each of the arbiters 50 excluding the arbiter 50 of the die Dn in the last stage outputs the read request selected through the arbitration to the arbiter 50 of the die D in the next stage. The arbiter 50 of the die Dn outputs the read request selected through the arbitration to the ROM 60 as a read request RREQ. The read request RREQ output from the arbiter 50 of the die Dn is also output to the service processors 20 and the cache memories 30 of all the dies D.

Multiple types of initialization programs to be executed by all the service processors 20 in the multi-die package 100 are stored in the ROM 60 in advance before the activation of the multi-die package 100. For example, the ROM 60 is a flash memory having a serial interface. The ROM 60 outputs, as data DT, data matching the read request RREQ from the arbiter 50 of the die Dn (for example, some of instructions in the initialization programs). The ROM 60 is an example of a memory.

The service processor 20 of each die D receives the read request RREQ output by the arbiter 50 of the die Dn and the data DT output from the ROM 60. A signal line through which the read request RREQ output from the arbiter 50 of the die Dn is transferred to the service processors 20 and the cache memories 30 of the dies D is an example of a first signal line. A signal line through which the data DT output from the ROM 60 is transferred to the service processors 20 and the cache memories 30 of the dies D is an example of a second signal line.

When receiving the data DT responding to the read request issued to the SPI controller 40 based on a cache miss, the service processor 20 fetches the received data DT as an instruction. When receiving the data DT responding to the read request REQ from another die D and including the same address as in the read request issued to the SPI controller 40 based on the cache miss, the service processor 20 fetches the received data DT as an instruction.

In this way, the service processor 20 is able to fetch the data DT responding to a read request issued by the service processor 20 of another die D as an instruction. For example, the service processor 20 of each of the calculation processing dies D is able to receive the data DT responding to the read request for the initialization program for the calculation processing issued by any of the other calculation processing dies D. The service processors 20 of all the dies D are each able to receive the data DT responding to the read request for the common initialization program issued by any of the other dies D.

Thus, the initialization programs are kept from being transferred from the ROM 60 to the cache memory 30 for each of the dies D one by one. For this reason, the transfer time of the initialization programs in the entire multi-die package 100 may be made shorter and the initialization processing by the service processors 20 may be completed faster than in the case where the initialization program is transferred from the ROM 60 to each of the dies D one by one. As a result, it is possible to make the rise time from the activation of the multi-die package 100 to the start of the processing by the cores 10 shorter than in the case where the initialization programs are transferred from the ROM 60 to each of the dies D one by one.

When receiving the data DT responding to the read request REQ from another die D and including the same address as in the read request issued to the SPI controller 40 based on the cache miss, the service processor 20 cancels the read request. This configuration is able to keep the data DT responding to the read requests REQ including the same address from being output from the ROM 60 multiple times.

The cache memory 30 of each die D receives the read request RREQ output by the arbiter 50 of the die On and the data DT output from the ROM 60. The cache memory 30 reserves a data area for the address included in the read request. RREQ, and stores the data DT in the reserved data area. For example, the cache memory 30 holds the data DT in association with the read request RREQ.

Thus, the cache memory 30 may hold not only a read request REQ issued to the ROM 60 by the concerned die D due to a cache miss but also the data DT responding to the read request REQ issued to the ROM 60 by another die D due to a cache miss. For example, the cache memory 30 holds the data DT output from the ROM 60 in response to a read request REQ that is issued by another die D and that includes the same address as in a read request REQ issued by the concerned die D.

In the case of the configuration in which the cache memory 30 issues a read request to the SPI controller 40, the read request RREQ output from the arbiter 50 of the die Dn in the last stage is not transferred to the service processor 20 but is transferred only to the cache memory 30. When receiving the data DT responding to the read request RREQ including the same address as in a cache-missed read request, the cache memory 30 of each die D holds the received data DT. The data DT to be held in the cache memory 30 may bypass the service processor 20.

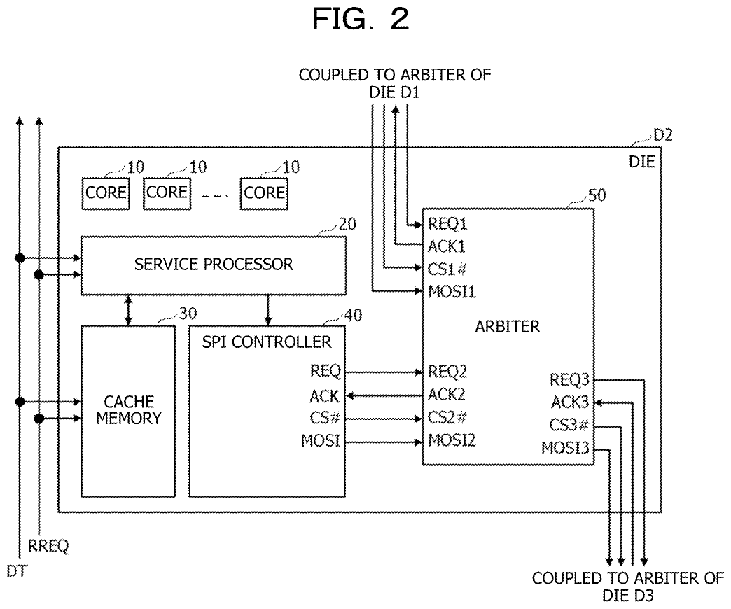

FIG. 2 illustrates an example of the die D2 in FIG. 1. Components which are the same as or similar to those illustrated in FIG. 1 are denoted with the same reference signs, and detailed descriptions thereof will be omitted. The SPI controller 40 includes a read request terminal REQ, an acknowledge terminal ACK, a chip select terminal CS#, and a data terminal Master-Out Slave-In (MOST). A sign# of the chip select terminal CS# indicates that a chip select CS# is active low. Although transfer of data or the like through the SPI bus is performed in synchronization with the clock, the clock is not illustrated in FIGS. 2 to 4.

The arbiter 50 includes read request terminals REQ1, REQ2, and REQ3, acknowledge terminals ACK1, ACK2, and ACK3, chip select terminals CS1#, CS2#, and CS3#, and data terminals MOSI1, MOSI2, and MOSI3. The chip select terminals CS1#, CS2#, and CS3# and the data terminals MOSI1, MOSI2, and MOSI3 are supplied with SPI interface signals. The data terminals MOSI1, MOSI2, and MOSI3 are serial terminals.

The read request terminal REQ1 and the acknowledge terminal ACK1 are respectively coupled to the read request terminal REQ3 and the acknowledge terminal ACK3 of the arbiter 50 of the die D1 in the previous stage. The chip select terminal CSI# and the data terminal MOSI1 are respectively coupled to the chip select terminal CS3# and the data terminal MOSI3 of the arbiter 50 of the die D1 in the previous stage.

The read request terminal REQ2 and the acknowledge terminal ACK2 are respectively coupled to the read request terminal REQ and the acknowledge terminal ACK of the SPI controller 40 of the concerned die D2. The chip select terminal CS2# and the data terminal MOSI2 are respectively coupled to the chip select terminal CS# and the data terminal MOSI of the SPI controller 40 of the concerned die D2.

The read request terminal REQ3 and the acknowledge terminal ACK3 are respectively coupled to the read request terminal REQ1 and the acknowledge terminal ACK1 of the arbiter 50 of the die D3 in the next stage. The chip select terminal CS3# and the data terminal MOSI3 are respectively coupled to the chip select terminal CS1# and the data terminal MOSI1 of the arbiter 50 of the die D3 in the next stage.

When receiving a read request based on a cache miss from the service processor 20, the SPI controller 40 outputs a read request REQ to the arbiter 50 and waits for an acknowledge ACK2 from the arbiter 50. When receiving the acknowledge ACK2 from the arbiter 50, the SPI controller 40 outputs a chip select CS# to the arbiter 50. The SPI controller 40 serially outputs the read command and the address included in the read request from the service processor 20 from the data terminal MOSI to the arbiter 50.

When receiving only one of read requests REQ1 and REQ2, the arbiter 50 selects the received read request REQ (REQ1 or REQ2) and outputs the selected read request as a read request REQ3. When receiving both of the read requests REQ1 and REQ2 (for example, when a contention occurs between the read requests REQ1 and REQ2), the arbiter 50 selects one of the received read requests REQ1 and REQ2 through arbitration and outputs the selected read request as a read request REQ3.

For example, when receiving both of the read requests REQ1 and REQ2, the arbiter 50 may alternately select one of the read requests REQ1 and REQ2 (round-robin). Thus, the arbitration processing by the arbiter 50 may be simplified. When receiving both of the read requests REQ1 and REQ2, the arbiter may select the read request REQ2 received from the service processor 20 of the concerned die D2 with a frequency lower than a frequency of selecting the read request REQ1 received from the arbiter 50 of the die D1 in the previous stage. As a result, the frequencies of selecting the read requests REQ from the service processors 20 of the dies D may be substantially equalized. For example, the frequencies of issuing the read requests REQ to the ROM 60 by all the dies D may be substantially equalized.

The arbiter 50 waits for reception of an acknowledge ACK3, which is a response to the read request REQ3, from the die D3. When the arbiter 50 of the die Dn in the last stage selects the read request REQ, the acknowledge ACK3 is sequentially transferred from the arbiter 50 of the die Dn in the last stage.

The arbiter 50 outputs the acknowledge ACK3 to the acknowledge terminal ACK (ACK1 or ACK2) relevant to the read request REQ selected through the arbitration. The arbiter 50 outputs a chip select CS# and data MOST (a read command and an address) received from the output destination of the acknowledge ACK3 to the chip select terminal CS3# and the data terminal MOSI3.

For example, when the arbiter 50 selects the read request REQ from the SPI controller 40 of the concerned die D2 through arbitration, the arbiter 50 transfers the selected read request REQ to the read request terminal REQ3. When receiving the acknowledge ACK3 from the acknowledge terminal ACK3, the arbiter 50 transfers the acknowledge ACK3 to the SPI controller 40. The arbiter 50 outputs, to the chip select terminal CS3# and the data terminal MOSI3, the chip select. CS# and the data MOST output in response to the transferred acknowledge ACK3 from the SPI controller 40. The chip select CS# and the data MOST output from the SPI controller 40 are output to the ROM 60 via the arbiter 50 of the die Dn in the last stage.

The other dies D3, D4, . . . , Dn-1 excluding the die D1 in the first stage and the die Dn in the last stage have the same configuration as that illustrated in FIG. 2. The die Dl in the first stage has the same configuration as that illustrated in FIG. 2 except that the request terminal REQ1, the acknowledge terminal ACK1, the chip select terminal CS1#, and the data terminal MOSI1 are set to be invalid without being coupled to any signal lines.

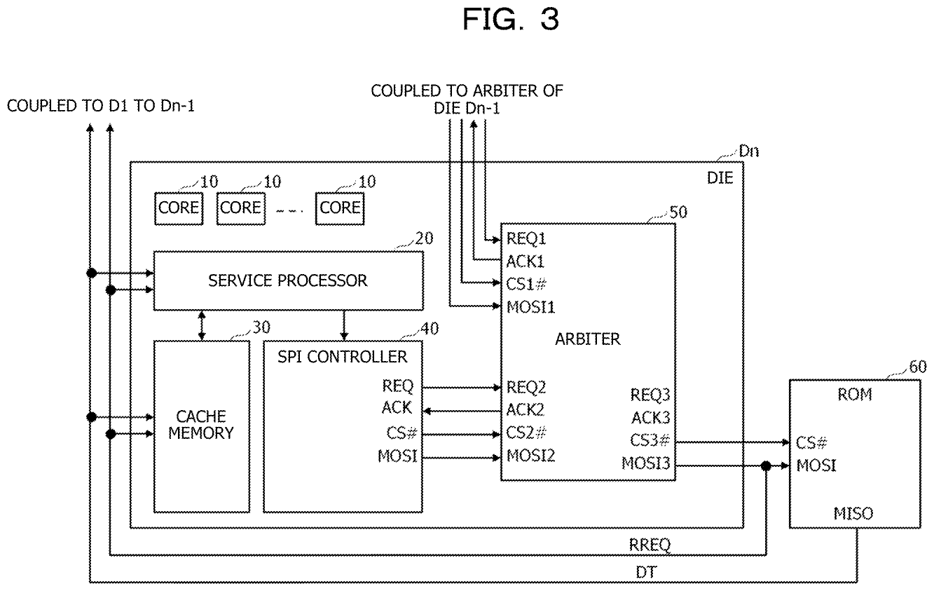

FIG. 3 illustrates an example of the die Dn illustrated in FIG. 1. Components which are the same as or similar to those illustrated in FIG. 2 are denoted with the same reference signs, and detailed descriptions thereof will be omitted. In the arbiter 50 of the die Dn, the read request terminal REQ3 and the acknowledge terminal ACK3 are set to be invalid without being coupled to any signal lines. In the arbiter 50 of the die Dn, the chip select terminal CS3# and the data terminal MOSI3 are coupled to a chip select terminal CS# and a data terminal MOST of the ROM 60, respectively. The other configuration of the die Dn are similar to the configuration of the die D2 illustrated in FIG. 2.

When receiving only one of the read requests REQ1 and REQ2, the arbiter 50 of the die Dn outputs an acknowledge ACK to the acknowledge terminal ACK (ACK1 or ACK2) relevant to the received read request REQ (REQ1 or REQ2). When receiving both of the read requests REQ (REQ1 and REQ2), the arbiter 50 selects one of the received read requests REQ through arbitration. The arbiter 50 outputs the acknowledge ACK to the acknowledge terminal ACK (REQ1 or REQ2) relevant to the selected read request REQ (ACK1 or ACK2).

The arbiter 50 outputs a chip select CS# and data MOSI (a read command and an address) received from the output destination of the acknowledge ACK to the ROM 60 via the chip select terminal CS3# and the data terminal MOSI3. The arbiter 50 transfers the data MOSI (the read command and the address) output to the data terminal MOSI3, as a read request RREQ to the service processors 20 and the cache memories 30 of all the dies D.

The ROM 60 executes a read operation based on the read request RREQ (the read command and the address) included in the data MOST received together with the chip select CS#. The ROM 60 outputs the data DT read from a memory cell array from a data terminal Master-In Slave-Out (MISO). The data DT output from the MISO terminal of the ROM 60 is output to MISO terminals of the service processors 20 and the cache memories 30 of all the dies D1 to Dn.

The service processor 20 of the issuer of the read request. RREQ output to the ROM 60 detects output of the issued read request RREQ to the ROM 60 based on the address included in the read request RREQ output from the arbiter 50 of the die Dn. Similarly, the service processor 20 of the issuer of the read request REQ including the same address as in the read request RREQ output to the ROM 60 detects output of the issued read request REQ to the ROM 60. The service processor 20 receives the read request RREQ at the MISO terminal. At least one service processor 20 that detects the output of the issued read request REQ to the ROM 60 fetches the data DT output from the ROM 60 as an instruction to execute the initialization program.

The cache memory 30 having a cache miss occurred detects the read request RREQ including the cache-missed address and thereby detects output of the cache-missed read request REQ to the ROM 60. The cache memory 30 receives the read request RREQ at the MISO terminal. The cache memory 30 having the cache miss occurred stores the data DT output from the ROM 60 in a data area reserved for the cache-missed address.

The service processor 20 other than the issuer of the read request RREQ output to the ROM 60 does not fetch the data DT output from the ROM 60. Similarly, the cache memory 30 having no cache miss occurred and the cache memory 30 in which the cache-missed address is different from the address in the read request REQ output from the arbiter 50 of the die Dn do not fetch the data DT output from the ROM 60.

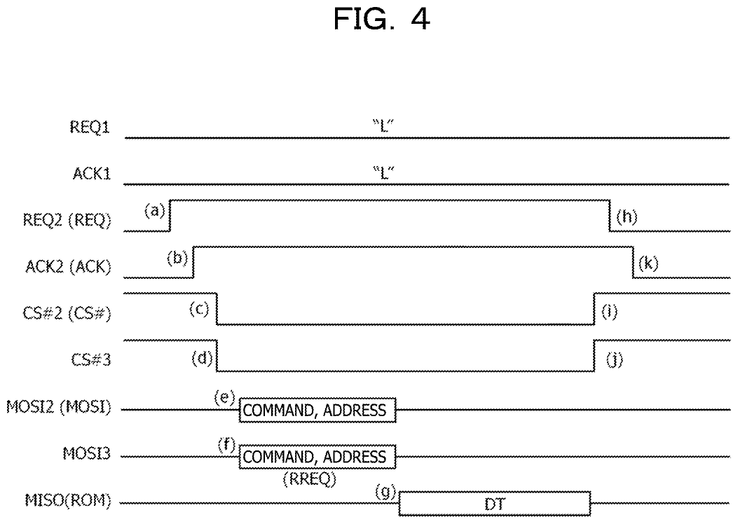

FIG. 4 illustrates an example of operations of the SPI controller 40 and the arbiter 50 of the die Dn illustrated in FIG. 3. Signals expressed in parentheses represent signals of the SPI controller 40. In FIG. 4, the SPI controller 40 of the die Dn receives a read request output by the service processor 20 based on a cache miss, and outputs a read request REQ at the high level to the read request terminal REQ2 of the arbiter 50 ((a) in FIG. 4).

The arbiter 50 does not receive a read request REQ1 from the die Dn-1 (low level“L”), Therefore, the arbiter 50 selects the read request REQ2 and outputs an acknowledge ACK2 to the SPI controller 40 via the acknowledge terminal ACK2 ((b) in FIG. 4). Until the output of the data DT from the ROM 60 is completed, the arbiter 50 keeps the acknowledge ACK2 at the high level. The acknowledge ACK1 is kept at the low level “L”.

Receiving the acknowledge ACK2 at the acknowledge terminal ACK, the SPI controller 40 outputs a chip select CS# at the low level to the chip select terminal CS2# of the arbiter 50 ((c) in FIG. 4). Until the output of the data DT from ROM 60 is completed, the SPI controller 40 keeps the chip select CS# at the low level. The arbiter 50 outputs the chip select CS# from the SPI controller to the ROM 60 as a chip select CS# ((d) in FIG. 4).

Subsequent to the output of the chip select CS#, the SPI controller sequentially outputs a command and an address to the data terminal MOSI2 of the arbiter 50 ((e) in FIG. 4). The arbiter 50 sequentially outputs the command and the address from the SPI controller 40 as a read request RREQ to the data terminal MOST of the ROM 60 via the data terminal MOSI3 ((f) in FIG. 4).

While receiving the chip select CS3# at the low level, the ROM 60 is in an active state and executes a read operation based on reception of the command and the address. The ROM 60 sequentially outputs the data DT matching the address from the data terminal MISO ((g) in FIG. 4). The data DT is transferred to the service processors 20 and the cache memories 30 of all the dies D. The reading operation in which the ROM 60 outputs the data DT based on the read request output by the service processor 20 is completed.

Until the output of the data DT from the ROM 60 is completed, the SPI controller 40 keeps the read request REQ at the high level. For example, the service processor 20 of the die Dn outputs a reception completion notification of the data DT to the SPI controller 40 based on the reception of the data DT responding to the read request RREQ from the ROM 60.

Based on the reception completion notification of the data DT, the SPI controller 40 sets the read request REQ to the low level ((h) in FIG. 4). In this way, the SPI controller 40 continuously outputs the read request REQ until the read request is accepted. The SPI controller 40 returns the chip select CS# to the high level based on the reception completion notification of the data DT ((i) in FIG. 4). The arbiter 50 outputs the chip select CS# at the high level from the SPI controller 40 to the ROM 60 as the chip select CS3# ((j) in FIG. 4). In response to this, the ROM 60 is set to an unselected state.

For example, the arbiter 50 sets the chip select CS3# to be output to the ROM 60 to the low level, and then, after the output of the data DT from the ROM 60 is completed, sets the acknowledge ACK2 to the low level ((k) in FIG. 4). While the acknowledge ACK2 is set to the high level, the arbiter 50 suspends arbitration operations for other read requests REQ.

Operations performed by the arbiter 50 of the die Dn in response to reception of a read request REQ1 from the arbiter 50 of the die Dn-1 are similar to those illustrated in FIG. 4. In this case, the read request REQ1, the acknowledge ACK1, the chip select CS1#, and the data MOSI1 have the same waveforms as those of the read request REQ2, the acknowledge ACK2, the chip select CS2#, and the data MOSI2 in FIG. 4.

Operations performed by the arbiter 50 of the die D other than the die Dn in response to reception of a read request REQ from the SPI controller 40 of the concerned die D are similar to those illustrated in FIG. 4 except that the data MOSI is transferred to the arbiter 50 of the die D in the next stage instead of the ROM 60. Operations performed by the arbiter 50 of the die D other than the die Dn in response to reception of a read request REQ1 from the arbiter 50 of the die D in the previous stage are also similar to those illustrated in FIG. 4. In this case, the read request REQ1, the acknowledge ACK1, the chip select CS1#, and the data MOSI1 have the same waveforms as those of the read request REQ2, the acknowledge ACK2, the chip select CS2#, and the data MOSI2 in FIG. 4.

When the arbiter 50 receives both of the read request REQ2 from the SPI controller 40 of the concerned die Dn and the read request REQ1 from the arbiter 50 of the die Dn-1 in the previous stage, the arbiter 50 performs processing for the read request REQ received earlier, for example. The processing for the read request REQ received later (for example, output of an acknowledge ACK to the issuer of the read request REQ) is waited until the processing for the read request REQ received earlier is completed.

In this embodiment, the cache memory 30 is able to hold not only the read request REQ issued to the ROM 60 by the concerned die D due to a cache miss but also the data DT responding to the read request REQ issued to the ROM 60 by another die D due to a cache miss as described above. Accordingly, the service processor 20 is able to fetch, as an instruction, the data DT responding to the read request issued by the service processor 20 of the other die D.

Therefore, it is possible to keep the initialization programs from being transferred from the ROM 60 to each of the dies D one by one, and to improve the efficiency in transfer of the initialization program to the multiple dies D. For example, the service processor 20 of each of the calculation processing dies D is able to receive the data DT responding to the read request for the initialization program for the calculation processing issued by any of the other calculation processing dies D. The service processors 20 of all the dies D are each able to receive the data DT responding to the read request for the common initialization program issued by any of the other dies D.

For this reason, the transfer time of the initialization programs in the entire multi-die package 100 may be made shorter and the initialization processing by the service processors 20 may be completed faster than in the case where the initialization program is transferred from the ROM 60 to each of the dies D one by one. For example, it is possible to quickly complete the initialization processing of the multiple dies D each of which executes any one of the multiple types of processing. As a result, it is possible to make the rise time from the activation of the multi-die package 100 to the start of the processing by the cores 10 shorter than in the case where the initialization programs are transferred from the ROM 60 to each of the dies D one by one.

Each die D is equipped with the arbiter 50. Thus, even in a case where the number of dies D mounted on the multi-die package 100 is changed, the multiple arbiters 50 are just coupled in series and thereby are enabled to perform the arbitration processing on read requests to the ROM 60. As a result, the arbiters for arbitrating between read requests REQ from the multiple dies D does not have to be designed depending on the number of dies D mounted on the multi-die package 100. Consequently, multi-die packages 100 equipped with various numbers of dies D may be rapidly released in the marketplace.

The read request RREQ output to the ROM 60 by the arbiter 50 of the die Dn is transferred to the service processors 20 and the cache memories 30 of all the dies D via the signal line. Therefore, the service processors 20 and the cache memories 30 are able to recognize the address in a cache-missed read request issued by the service processor 20 of another die D.

The service processor 20 is able to fetch, as an instruction, the data DT responding to a read request issued by the service processor 20 of another die D. The cache memory 30 is able to store the data DT responding to a read request issued by the service processor 20 of another die D in the data area. When read requests including the same address are output from multiple service processors 20, the above configuration enables the multiple service processors 20 to fetch the instruction without outputting the data DT responding to the read requests from the ROM 60 multiple times. The above configuration also enables the multiple cache memories 30 to store the data DT without outputting the data DT responding to the read requests from the ROM 60 multiple times.

When receiving the data DT responding to the read request REQ from another die D including the same address as in the read request issued to the SPI controller 40 based on a cache miss, the service processor 20 cancels the read request. This configuration is able to keep the data DT responding to the read requests REQ including the same address from being output from the ROM 60 multiple times.

When receiving two read requests REQ, the arbiter 50 alternately selects one of the two read requests REQ, so that the arbitration processing may be simplified. Alternatively, when receiving two read requests REQ, the arbiter 50 selects the read request. REQ output by the service processor 20 of the concerned die D2 with a frequency lower than a frequency of selecting the read request REQ received from the arbiter 50 of the die D in the previous stage. As a result, the frequencies of selecting the read requests REQ from the service processors 20 of the dies D may be substantially equalized. For example, the frequencies of issuing the read requests REQ to the ROM 60 by all the dies D may be substantially equalized.

Features and advantages of the embodiments are clarified from the above detailed description. The scope of claims is intended to cover the features and advantages of the embodiments described above within a scope not departing from the spirit and scope of right of the claims. Any person having ordinary skill in the art may easily conceive every improvement and alteration. Accordingly, the scope of inventive embodiments is not intended to be limited to that described above and may rely on appropriate modifications and equivalents included in the scope disclosed in the embodiments.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A multi-die package comprising:
a plurality of dies each including a processor core, a service processor, a cache memory that holds an instruction to be executed by the service processor, and an arbiter that arbitrates between read requests issued from the service processors, wherein
the plurality of the arbiters respectively mounted on the plurality of dies are coupled in series,
each of the arbiters excluding the arbiter in the first stage and the arbiter in the last stage arbitrates between a read request from the service processor of the concerned die and a read request selected through arbitration by the arbiter in the previous stage, and outputs the read request selected through the arbitration to the arbiter in the next stage,
the arbiter in the last stage arbitrates between a read request from the service processor of the concerned die and a read request selected through arbitration by the arbiter in the previous stage, and outputs the read request selected through the arbitration to a memory, and
the cache memory of each of the plurality of dies holds an instruction output from the memory in response to each of read requests output from the service processors of the concerned die and any of the other dies in association with the read request.

2. The multi-die package according to claim 1, further comprising:
a common first signal line through which the read request output from the arbiter in the last stage to the memory is transferred to the cache memories of the plurality of dies; and
a common second signal line through which the instruction output from the memory in response to the read request output by the arbiter in the last stage is transferred to the cache memories of the plurality of dies.

3. The multi-die package according to claim 2, wherein
when the cache memory of each of the plurality of dies receives, from the arbiter in the last stage, a read request including the same address as an address included in a read request output by the service processor of the concerned die, the cache memory holds the instruction output from the mem in response to the received read request.

4. The multi-die package according to claim 2, wherein,
the service processor of each of the plurality of dies
receives the read request output by the arbiter in the last stage through the first signal line,
receives the instruction output by the memory through the second signal line, and
when receiving an instruction responding to a read request including the same address as an address included in the read request output to the arbiter of the concerned die, fetches the received instruction.

5. The multi-die package according to claim 4, wherein,
when the service processor of each of the plurality of dies receives an instruction responding to a read request that is output by the service processor of another die and that includes the same address as the address included in the read request output to the arbiter of the concerned die, the service processor cancels the read request output to the arbiter of the concerned die.

6. The multi-die package according to claim 1, wherein
when contention occurs between the read request output by the service processor of the concerned die and the read request received from the arbiter in the previous stage, the arbiter alternately selects one of the read requests.

7. The multi-die package according to claim 1, wherein
when contention occurs between read requests, the arbiter selects a read request output by the service processor of the concerned die with a frequency lower than a frequency of selecting a read request received from the arbiter in the previous stage.

8. The multi-die package according to claim 1, wherein
each of the plurality of dies executes any one of a plurality of types of processing by using the corresponding processor core, and
an instruction executed by the service processor of each of the plurality of dies is an instruction to initialize the concerned die in accordance with the processing to be executed by the concerned die.
